(19) United States
(12) Patent Application Publication
(10) Pub. No.: US 2011/0174500 A1
(43) Pub. Date: Jul. 21, 2011

(54) CONNECTING ASSEMBLY

(76) Inventors: Mark Davies, Aberdeenshire (GB); Robin Derrick, Aberdeenshire (GB)

(21) Appl. No.: 12/740,303

(22) PCT Filed: Oct. 29, 2008
(86) PCT No.: PCT/GB2008/003689

§ 371 Date: Jan. 3, 2011

(30) Foreign Application Priority Data
Oct. 31, 2007 (GB) 0721353.1

(51) Int. Cl. H01R 13/62; E21B 23/00

(52) U.S. Cl. 166/378; 439/345; 439/372

(57) ABSTRACT

A connecting assembly (14) comprises a first connector (10) defining a profiled portion (16) and a second connector (12) comprising a coupling member (18) adapted to be translated to selectively engage with the profiled portion (16) of the first connector (10). The assembly (14) also comprises a supporting member (20) adapted to be translated to selectively secure said coupling member (18) in engagement with the profiled portion (16) of the first connector (10). Drive means (21) is contained within one of the first and second connectors (10, 12) and is adapted to translate the supporting member (20). One disclosed use of the connecting assembly (14) is in a wellbore tool deployment system.

### FIELD OF THE INVENTION

The present invention relates to a connecting assembly, and in particular, but not exclusively, to an electro-mechanical connecting assembly for use in a tool deployment system.

### BACKGROUND TO THE INVENTION

The applicant's co-pending International patent application PCT/GB2004/000138 discloses a system for the storage and deployment of wireline conveyed well intervention tooling using a subsea intervention device. In the disclosed system a number of wireline tools are stored in a tool storage package in an arrangement surrounding a central deployment bore which communicates with a wellbore. In use, a selected tool is displaced from a storage position into the deployment bore, with an upper portion of the tool being coupled to wireline via a suitable connector, after which the tool may be deployed on the wireline into the wellbore.

The connector must be capable of providing a mechanical connection, and in some applications must be capable of also providing an electrical connection for power and/or communication purposes. It is essential that a robust connection, both mechanically and electrically, is achieved and maintained to prevent loss of the tool and ensure electrical connectivity when in the wellbore. As is well known in the art, remedial action to recover a dropped tool can be expensive and time consuming, with added complications where subsea intervention systems are used. Additionally, it is essential that the connector is capable of safely and controllably releasing the tool to be once again stored in the tool storage package. Furthermore, the connector should be reusable such that an intervention operation utilising a number of different tools may be carried out without interruption due to a failure or inadequacy of a tool connector.

### SUMMARY OF THE INVENTION

According to a first aspect of the present invention, there is provided a connecting assembly comprising:
a first connector defining a profiled portion;
a second connector comprising a coupling member adapted to be translated to selectively engage with the profiled portion of the first connector;
a supporting member adapted to be translated to selectively secure said coupling member in engagement with the profiled portion of the first connector; and
drive means contained within one of the first and second connectors and adapted to translate the supporting member.

The second connector may comprise the supporting member. The drive means may be contained within the connector comprising the supporting member.

In use, during make-up of the assembly the first and second connectors may be brought together and the coupling member translated to engage with the profiled portion, following which the supporting member may be translated by the drive means to secure the coupling member in position. Accordingly, by virtue of securing the coupling member in engagement with the profiled portion, the first and second connectors may be secured together. Furthermore, during disconnection of the assembly the supporting member may be translated out of engagement with the profiled portion.

The present invention advantageously eliminates the requirement for external drive sources to effect translation of the supporting member. Furthermore, providing a drive means within the connector assembly to translate the supporting member may permit the connecting assembly to be operated remotely and to be repeatedly made-up and disconnected.

The connecting assembly may be adapted for use at a downhole location. It should be understood that a downhole location includes any portion of a well assembly which is isolated from the environment, and includes subterranean portions of a well assembly such as well bores, and also surface located portions of a well, such as Christmas trees, BOPs, subsea well head assemblies, riser assemblies and the like.

The connectors may be of a male and female type, such that at least a portion of one of the first and second connectors may be adapted to be received within the other of the first and second connectors.

The drive means may comprise hydraulic drive means, electrical drive means or the like. In one embodiment the drive means may comprise a hydraulic piston arrangement, such as an annular piston arrangement or the like. In one embodiment the drive means may comprise an electric motor and optionally a gearing arrangement. The drive means may be adapted to be coupled to the supporting member, for example via a gearing arrangement or the like.

The connecting assembly may further comprise a translation mechanism interposed between the drive means and the supporting member and adapted to transmit driving force from the drive means to the supporting member. The translation mechanism may be adapted to rotate the supporting member. In one embodiment the translation mechanism is adapted to axially translate the supporting member.

The translation mechanism may comprise a displacement member coupled between the drive means and the supporting member, wherein movement of the displacement member by the drive means may effect movement of the supporting member. The displacement member may be adapted to be axially translated by the drive means. For example, the displacement member may be engaged by or form part of a linear piston arrangement or the like. Alternatively, the displacement member may comprise a rack arrangement adapted to be engaged by a pinion driven by the drive means. Alternatively further, the displacement member may define or comprise a carriage adapted to be engaged by a lead screw formed on or with the drive means.

In one embodiment, the displacement member may be adapted to be rotatably translated by the drive means. For example, the displacement member may be rotatably coupled to the drive means, either directly or indirectly via a gearing arrangement or the like. In embodiments of the present invention a connecting collar is provided and extends between a drive shaft of the drive means and a driven shaft of the displacement member.

The second connector may further comprise a coupling arrangement disposed between the displacement member and the supporting member, wherein said coupling arrangement is adapted to permit movement of the displacement member to effect movement of the supporting member. The coupling arrangement may be adapted to permit movement of the displacement member to cause corresponding movement of the supporting member. For example, the coupling arrangement may comprise a rigid coupling. Alternatively, the coupling arrangement may be adapted to permit movement of the displacement member to be converted to a dissimilar movement of the supporting member. The coupling arrangement may be adapted to permit rotational movement of the displacement member to be converted to axial or linear movement of the supporting member.

The coupling arrangement may comprise an anti-rotation mechanism adapted to prevent the supporting member from being rotated. The anti-rotation mechanism may comprise a key and key-way arrangement. Alternatively, the anti-rotation mechanism may comprise an inter-engaging, non-round profiled mating arrangement defined between the supporting member and a further component of the second connector.

The coupling arrangement may comprise a threaded connection, wherein a threaded portion on the displacement member engages a corresponding threaded portion on the supporting member, such that rotation of the displacement member effects axial or linear movement of the supporting member.

In one embodiment at least one of the displacement member and supporting member may define a track and the other of the displacement member and supporting member may comprise an extension element, such as a pin or the like, adapted to be engaged within said track. The track may extend both axially and circumferentially to define a spiral arrangement such that rotation of the displacement member will effect axial or linear movement of the supporting member. In one embodiment the track may be formed on the supporting member and the extension element is provided on the displacement member. The track may be defined by a channel, slot, recess, lip, or the like.

The supporting member may be adapted to support the coupling member, either directly or indirectly, when the coupling member is configured to engage the profiled portion. The supporting member may be adapted to support an inner surface of the coupling member. Alternatively, the supporting member may be adapted to support an outer surface of the coupling member.

The supporting member may be adapted to engage the coupling member, either directly or indirectly. The supporting member may comprise a supporting surface adapted to be selectively engaged with the coupling member. The supporting surface may be located adjacent an end portion of the supporting member. In this arrangement the supporting member may be translated to displace said end portion away from and towards the coupling member.

Alternatively, the supporting surface may be located adjacent a recess within the supporting member. The recess may be conveniently termed a de-supporting recess. In this arrangement the supporting member may be translated to displace said de-supporting recess into and out of alignment with the coupling member. When the de-supporting recess is displaced out of alignment with the coupling member the supporting surface may engage said coupling member. Additionally, when the de-supporting recess is displaced into alignment with the coupling member, said member may subsequently be displaced into said recess. The de-supporting recess may be defined by a slot, depression, orifice, channel, stepped portion, taper or the like.

In one embodiment, the supporting member may be adapted to be translated in an axial direction relative to the second connector to selectively secure the coupling member in engagement with the profiled portion. In this arrangement the supporting surface of the supporting member may be aligned substantially parallel with the longitudinal axis of the second connector. Alternatively, the supporting surface may be axially tapered. In this arrangement the supporting surface may define a linear cam. The linear cam may positively displace the coupling member upon engagement therewith.

In a further embodiment, the supporting member may alternatively, or additionally, be adapted to be translated in a rotational direction to selectively secure the coupling member in engagement with the profiled portion. In this arrangement the supporting surface of the supporting member may be aligned substantially parallel with the longitudinal axis of the second connector. Alternatively, the supporting surface may be circumferentially profiled. In this arrangement the supporting surface may define a rotary cam. For example, the supporting surface may define at least one lobe adapted to be rotationally displaced into and out of engagement with the coupling member.

In use, translation of the supporting member may cause corresponding translation of the coupling member. For example, the coupling member may be secured to the supporting member, for example by an interlocking profile, such as a dovetail arrangement or the like.

The supporting member may be at least partially tubular. Alternatively, the supporting member may comprise a solid body portion.

The coupling member may be adapted to be translated between an extended position and a retracted position. The coupling member may be adapted to engage the profiled portion when said member is in its extended position, and to disengage the profiled portion when said member is in its retracted position. The coupling member may be translated between retracted and extended positions in a lateral direction. The coupling member may be adapted to be moved laterally outwardly to move towards its extended position and engage the profiled portion. Alternatively, the coupling member may be adapted to be moved laterally inwardly to move towards its extended position and engage the profiled portion.

In one embodiment of the present invention, the coupling member may be locatable in its retracted position during make-up of the connecting assembly until the coupling member and profiled portion are brought into alignment, at which point the coupling member may be moved towards its extended position to engage the profiled portion.

The coupling member may be biased towards its extended position. In this arrangement the coupling member may be adapted to be displaced towards its retracted position against said bias during make-up of the connecting assembly until the coupling member and profiled portion are aligned, at which point the coupling member may be biased towards its extended position to engage the profiled portion. In this embodiment, the coupling member may be adapted to be displaced towards its retracted position during make-up of the connecting assembly by engagement with the first connector. Alternatively, or additionally, the second connector may further comprise a positive displacement mechanism adapted to displace said coupling member towards its retracted position. For example, the positive displacement mechanism may comprise a lever arrangement, cam arrangement or the like.

Alternatively, the coupling member may be biased towards its retracted position. Alternatively further, the coupling member may be freely locatable between the extended and retracted positions such that no preferential bias is applied to the coupling member. In this arrangement the coupling member may be adapted to be positively displaced between its retracted and extended positions.

The profiled portion may be formed in a surface region of the first connector. The profiled portion may be formed in an outwardly facing surface of the first connector. In this arrangement the surface region of the first connector comprising the profiled portion may be adapted to be received within a portion of the second connector. Alternatively, the profiled portion may be defined in an inwardly facing surface of the first connector. In this arrangement the surface of the first connector comprising the profiled portion may be adapted to surround a portion of the second connector.

In one embodiment, the profiled portion may comprise a recess formed in a portion of the first connector. A single recess may be provided. Alternatively, a plurality of recesses may be provided to collectively define the profiled portion. The recess may continuously, or discontinuously, extend around a peripheral surface of the first connector. The recess may be annular. The recess may be defined by a channel, depression, lip, stepped portion, bore, taper, rabbet or the like.

The coupling member may be mounted, for example slidably mounted, within a guide recess formed in a portion of the second connector. The guide recess may be adapted to permit the coupling member to be moved in a selected direction or in a selected plane of motion. The guide recess may be formed in a sleeve portion of the second connector. The guide recess within the second connector may be in the form of a bore, slot, depression, channel or the like.

Alternatively, or additionally, the coupling member may be mounted on an axially extending member or finger. Advantageously, the finger is adapted to be laterally deflected. The coupling member may be mounted on a free end of the axially extending finger, wherein an opposite end of said finger is fixed relative to the second connector. The axially extending finger may resiliently support the coupling member. In this arrangement, displacement of the coupling member may be permitted by deflection of the finger. Advantageously, the resilience of the finger may bias the coupling member towards a preferential position. Advantageously, the finger and coupling member may collectively define a collet, or at least a portion of a collet.

A plurality of coupling members may be provided. The coupling members may be circumferentially distributed around a portion of the second connector. Alternatively, or additionally, the coupling members may be axially distributed along a portion of the second connector.

The connecting assembly may further comprise a sensor arrangement adapted to determine the state of connection of the first and second connectors. Advantageously, the sensor arrangement may be adapted to provide information to confirm that a successful connection has been made. Additionally, the sensor arrangement may be adapted to provide information to confirm that a connection has not yet been made or has successfully been broken. Additionally, the sensor arrangement may be adapted to provide information to allow a user to determine the relative positioning of the first and second connectors to thus determine the state of the connection.

In one embodiment the sensor arrangement may comprise a first sensor adapted to sense the position of the first connector relative to the second connector. The first sensor may comprise a plunger mounted in one of the connectors and adapted to be engaged by the other of the connectors. The displacement of the plunger may provide information relating to the relative positioning of the connectors. The plunger may comprise a magnetic material and the first sensor may further comprise a hall effect sensor, such that movement of the plunger relative to the hall effect sensor may vary the sensed magnetic flux. Accordingly, the relative positioning of the first and second connectors may be inferred from the relative positioning of the plunger and the hall effect sensor.

The sensor arrangement may further comprise a second sensor adapted to sense the position of the supporting member relative to the coupling member. Accordingly, the second sensor may be utilised to determine if the supporting member of the first connector is in a position to secure the coupling member in engagement with the profiled portion of the first connector. The second sensor may comprise a magnetic reference body mounted relative to the supporting member or associated component, such as a displacement member, and a hall effect sensor mounted in proximity to the magnetic reference body. Advantageously, in use, movement of the supporting member or associated component will cause the magnetic flux sensed by the hall effect sensor to vary. As such, the position of the supporting member may be inferred from the sensed location of the magnetic reference body.

Accordingly, the first and second sensors may collectively provide sensory feedback information sufficient to determine if the first and second connectors are in engagement and if the supporting member is in a position to secure the coupling member in engagement with the profiled portion. Additionally, utilising hall effect sensors permits the relative position and state of the connection to be established.

The connecting assembly may further comprise an anti-rotation mechanism adapted to prevent or at least minimise relative rotation of the first and second connectors when secured together. The anti-rotation mechanism may comprise an inter-engaging profiled arrangement defined between the first and second connectors. For example, the connectors may comprise inter-engaging or inter-leaving fingers, castellations, splines, or the like, or any suitable combination thereof. Advantageously, the inter-engaging profiled arrangement may comprise a tapered leading interface portion adapted to permit alignment of the inter-engaging profile to be achieved upon make-up of the connecting assembly.

In an alternative embodiment, the anti-rotation mechanism may comprise an axially extending channel formed in one of the first and second connectors, and a radially extending member in the other of the first and second connectors, wherein the radially extending member is adapted to be received with the channel to thus prevent relative rotation of the connectors. The channel may comprise an enlarged lead-in region, which may be in the form of a mule shoe or the like, such that upon make-up of the connecting assembly the radially extending member may be guided into the channel.

The radially extending member may be adapted to be moved between extended and retracted positions. In one embodiment said member may be biased towards an extended position and may be adapted to be depressed against said bias upon make-up of the connecting assembly. In this arrangement, if the radially extending member and channel are misaligned during make-up of the connecting assembly, the radially extending member will be depressed to permit make-up to be achieved, wherein any relative rotation of the first and second members may eventually result in alignment of the radially extending member and the channel such that the member is biased towards its extended configuration and into the channel. In this arrangement further relative rotation of the first and second connectors will be prevented.

In one embodiment, a plurality of axially extending channels may be provided. In this arrangement, the degree of relative rotation of the first and second connectors may be minimised before alignment of the radially extending member and one of the channels is achieved.

The radially extending member may be a pin or the like, which pin may comprise a domed head.

A plurality of radially extending members may be provided.

The connecting assembly may further comprise an electrical connector assembly comprising first and second electrical connectors. One of the first and second electrical connectors may comprise a pin and the other of the first and second electrical connectors may comprise a socket adapted to receive said pin to permit electrical communication between said first and second electrical connectors. In embodiments of the invention a plurality of pins and corresponding sockets may be provided. The electrical connector assembly may be adapted to be made-up in a fluid environment. The fluid environment may ,comprise water, hydrocarbons, or the like. The electrical connector may be adapted to be made-up in a high temperature and/or high pressure environment.

The connecting assembly may comprise means for sensing that an electrical connection has been successfully made. The connection confirmation means may comprise a control circuit mounted within one of the first and second connectors and adapted to transmit a signal, such that said signal will be communicated to a user through the connecting assembly only when a sufficient electrical connection has been made.

The connection confirmation means may comprise a unique identification signal, such that the identification of at least one of the connectors may be identified. This arrangement is particularly advantageous where the connecting assembly may be established by different connectors.

The connecting assembly of the present invention may be adapted to provide a connection between two desired components, modules, elements or the like. In one embodiment, at least one of the first and second connectors may be adapted to be coupled to a spoolable medium, such as wireline, slickline, coiled tubing or the like. In this arrangement the connecting assembly may be adapted for use is securing together different sections or types of spoolable media. Alternatively, the connecting assembly may be adapted to secure a further component to a spoolable medium. At least one of the first and second connectors may be adapted to be coupled to a tool assembly or tool string or the like. The tool string may comprise a downhole tool.

The connecting assembly may be adapted to be utilised in a well intervention apparatus, and particularly in a subsea well intervention apparatus.

According to a second aspect of the present invention there is provided a method of forming a connection between first and second connectors comprising the steps of:
bringing first and second connectors together;
translating a coupling member provided on the second connector into a profiled portion formed in the first connector; and
translating a supporting member via drive means mounted in at least one of the first and second connectors to secure said coupling member in engagement with the profiled portion of the first connector.

The various arrangements and operation of the connecting assembly described above in relation to the first aspect may also be applied to the method according to the second aspect.

According to a third aspect of the present invention, there is provided a tool deployment system comprising:
a tool
a spoolable medium; and
a connecting assembly adapted to couple said tool to said spoolable medium, wherein the connecting assembly comprises a first connector defining a profiled portion, a second connector comprising a coupling member adapted to be translated to selectively engage with the profiled portion of the first connector, a supporting member adapted to be translated to selectively secure said coupling member in engagement with the profiled portion of the first connector, and drive means for translating the supporting member.

The connecting assembly may comprise the connecting assembly according to the first aspect.

According to a fourth aspect of the present invention there is provided a method of performing a well intervention, said method comprising the steps of:
selecting a well intervention tool from a tool storage package;
securing said tool to a spoolable medium using the connecting assembly according to the first aspect; and
running said tool into a wellbore on the spoolable medium.

### BRIEF DESCRIPTION OF THE DRAWINGS

These and other aspects of the present invention will now be described, by way of example only, with reference to the accompanying drawings, in which:

FIGS. 1A and 1B are longitudinal cross-sectional views of a first connector and a second connector, respectively, of a connecting assembly according to an embodiment of the present invention;

FIG. 2 is an exploded view of the first connector shown in FIG. 1A;

FIG. 3 is an exploded view of the second connector shown in FIG. 1B;

FIGS. 4A, 4B and 4D show the first and second connectors of FIGS. 1A and 1B respectively in various stages of being made-up;

FIG. 4C shows an enlarged view of a region of FIG. 4B;

FIG. 4E shows and enlarged view of a region of FIG. 4D;

FIG. 5 is a longitudinal cross-sectional view of an alternative supporting member for use in the second connector shown in FIG. 1B

FIG. 6 is a lateral cross-sectional view of a further alternative supporting member for use in the second connector shown in FIG. 1B;

FIGS. 7A and 7B are longitudinal cross-sectional views of a first connector and a second connector, respectively, of a connecting assembly according to an alternative embodiment of the present invention;

FIGS. 8A and 8B are longitudinal cross-sectional views of a first connector and a second connector, respectively, of a connecting assembly according to another alternative embodiment of the present invention; and

FIGS. 8C and 8D are enlarged views of portions of the second connector shown in FIG. 8B.

### DETAILED DESCRIPTION OF THE DRAWINGS

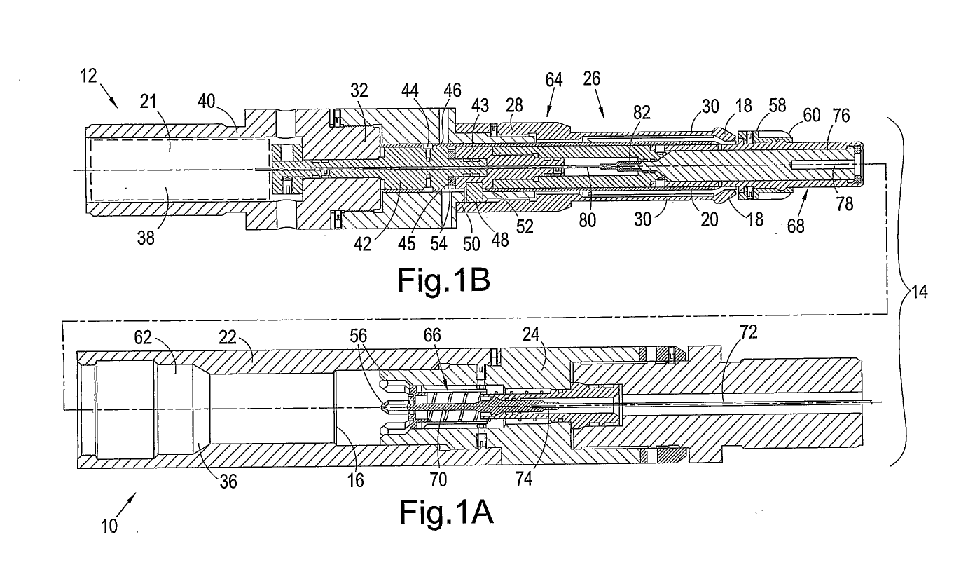

Reference is first made to FIGS. 1A and 1B of the drawings in which there is shown, respectively, a first connector, generally identified by reference numeral 10, and a second connector, generally identified by reference numeral 12. The first and second connectors 10, 12 collectively define a connecting assembly 14 according to an embodiment of an aspect of the present invention. One application of the connector is in a subsea tool deployment system for use in securing a tool selected from a tool storage package to a spoolable medium, such as wireline, to be subsequently run into a well bore. In this exemplary use, the first connector 10 is adapted to be secured to a tool (not shown), and the second connector 12 is adapted to be secured to the spoolable medium (not shown). The second connector 12 may be secured to the spoolable medium via a tractor, for example.

The first connector 10 defines a female connector, whereas the second connector 12 defines a corresponding male connector such that, in use, a portion of the second connector 12 is received within a portion of the first connector 10.

The first and second connectors 10, 12 are adapted to be releasably secured together via a coupling arrangement. In this respect, the first connector 10 defines a profiled portion 16 and the second connector 12 comprising a plurality of coupling members 18 adapted to be engaged with the profiled portion 16. The second connector 12 further comprises a tubular supporting member 20 adapted to be translated to selectively secure and lock said coupling members 18 in engagement with the profiled portion 16. The second connector 12 comprises a drive motor 21 (shown in broken outline) for use in translating the supporting member 20. The coupling arrangement will be described in further detail below.

The profiled portion 16 of the first connector 10 is defined by a tapered step formed in a tubular member 22, which tubular member 22 is adapted to receive a portion of the second connector 12. The tubular member 22 is threadably mounted on an electrical connection module 24.

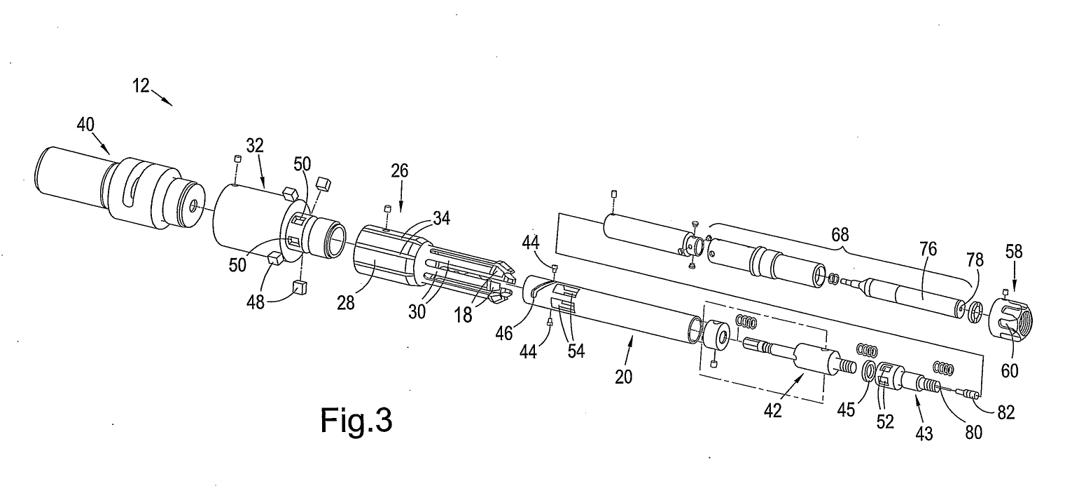

The coupling members 18 form part of a collet sleeve 26 comprising a tubular base member 28 which supports a plurality of axially extending fingers 30, wherein each finger 30 supports a respective coupling member 18 on a free end thereof. The collet sleeve 26 is threadably mounted, via the tubular base member 28, to a mounting member 32 forming part of the second connector 12. The collet sleeve 26 and mounting member 32 are also shown clearly in FIG. 3, which is an exploded view of the second connector 12. As shown in FIG. 3, the tubular base member 28 of the collet sleeve 26 comprises a plurality of axially extending channels 34 which, in use, permit fluid to be displaced past the collet sleeve and ejected from the connecting assembly 14 to prevent hydraulic locking of the assembly 14 during make-up. This arrangement therefore advantageously assists to accommodate for use of the assembly 14 in a fluid environment.

In use, when the first and second connectors 10, 12 are brought together the coupling members 18 will be deflected laterally or radially inwardly upon engagement with a frusto-conical or tapering surface 36 formed in the tubular member 22 of the first connector 10. When the coupling members 18 are aligned with the profiled portion 16 said members 18 will be displaced laterally or radially outwardly by the resilient fingers 30 into engagement with the profiled portion 16. Following this the tubular supporting member 20 of the second connector 12 may be axially translated by the motor 21 to sit behind the coupling members 18 to thus secure said members 18 in engagement with the profiled portion 16. In order to break the mechanical connection between the first and second connectors the tubular support member 20 may be translated by the motor 21 to de-support the coupling members 18 with the first and second connectors 10, 12 then being pulled apart to cause the coupling members to deflect radially inwards by virtue of the taper of the profiled portion 16. Axial translation of the supporting member 20 may be achieved by a translation mechanism which is interposed between the motor 21 and supporting member 20, which will be described in detail below.

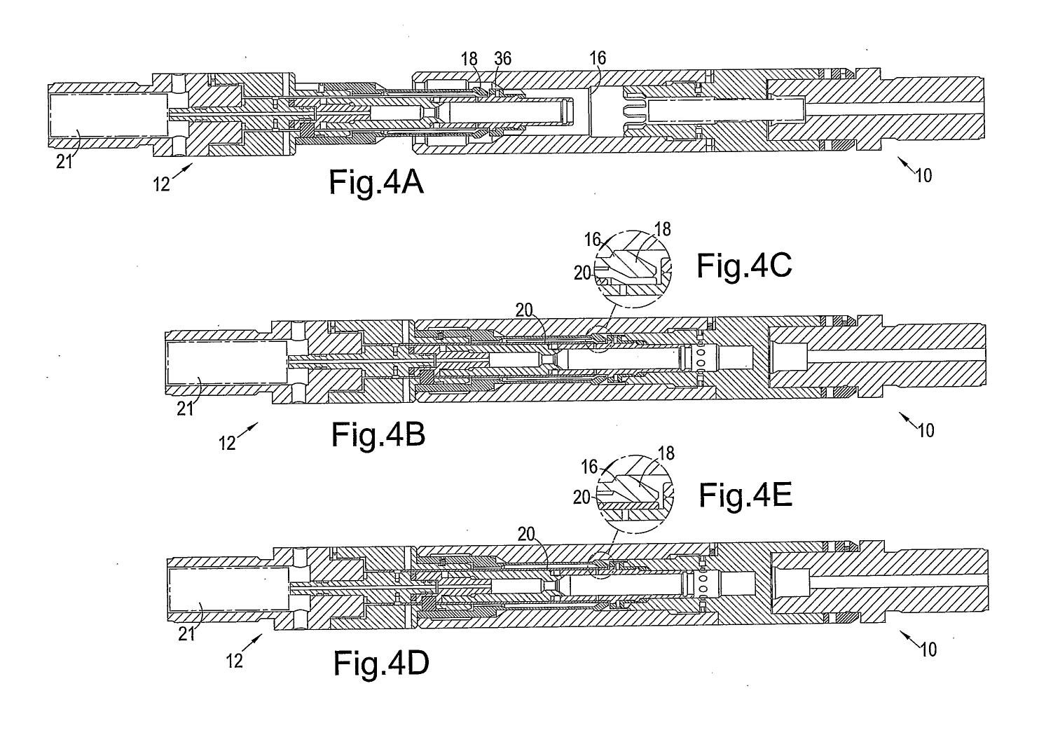

Various steps in making the connection between the first and second connectors 10, 12 are shown schematically in FIGS. 4A to 4E, reference to which is now made. The connectors are initially brought together, with the second connector 12 being received in the first connector 10, as shown in FIG. 4A. As described above, the coupling members 18 will be deflected radially inwardly upon engagement with the frusto-conical surface 36. When the second connector 12 is fully received within the first connector 10 and the coupling members 18 are aligned with the profiled portion 16, as shown in FIG. 4B, the coupling members 18 will be displaced radially outwardly into engagement with the profiled portion 16. At this stage the coupling members 18 are unsupported and as such the connection may be broken by pulling apart the connectors 10, 12. An enlarged view of an unsupported coupling member 18 shown engaged within the profiled portion 16 is shown in FIG. 4C. Following this, the tubular supporting member 20 is axially translated by the motor 21 to support the coupling members 18, as shown in FIG. 4D. In this state the coupling members 18 are locked in engagement with the profiled portion 16. An enlarged view of a coupling member 18 secured within the profiled portion 16 by the supporting member 20 is shown in FIG. 4E.

As noted above, the tubular supporting member 20 may be translated by the motor 21 via a translation mechanism which will now be described with reference to both FIGS. 1B and 3. The drive motor 21 and appropriate gearing arrangement (not shown) are mounted, at least partially, within a cavity 38 in an upper member 40 of the second connector 12. The motor is drivingly coupled to a displacement member 42 via the gearing arrangement such that the displacement member 42 may be rotated by the motor. The displacement member extends through the mounting member 32 and is rotatably supported by the mounting member 42 and a bush member 43, wherein a bearing 45 is positioned between the displacement and bush members 42, 43. The displacement member 42 comprises a pair of diametrically opposed and radially extending pins 44 which are received within respective tracks 46 formed in the supporting member 20. As can be seen most clearly in FIG. 3, the tracks are formed by slots which extend in a spiral fashion around the supporting member 20.

The supporting member 20 is secured against rotation by a plurality of key members 48 which extend through slots 50 in the mounting member 32 and are seated in depressions 52 in the bush member 43. The supporting member defines a plurality of axially extending key-ways 54 through which keys-ways 54 the key members 48 extend. Accordingly, the supporting member is free to slide in an axial direction but is prevented from rotation by the key and key-way arrangement. Thus, in use, rotation of the displacement member 42 by the motor 21 is translated to linear movement of the supporting member 20 by virtue of the interaction between the pins 44 and spiral tracks 46, and the key members 48 and respective key-ways 54.

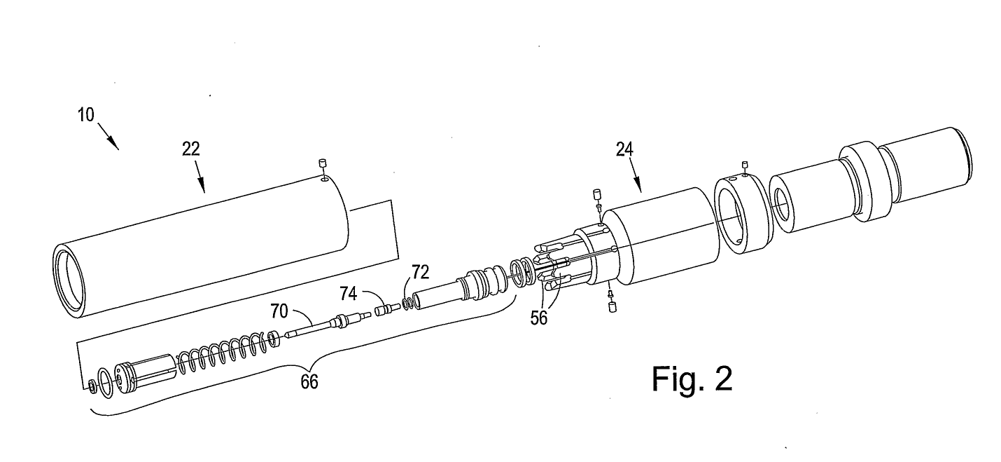

In some applications, relative rotation between the first and second connectors 10, 12 may not be desired. Accordingly, the first and second connectors 10, 12 of the present embodiment collectively define an anti-rotation mechanism, which will now be described with reference to FIGS. 1A, 1B, 2 and 3. The first connector comprises a plurality of axially extending fingers 56 formed on the electrical connection module 24 and the second connector 12 comprises a slotted member 58 having a plurality of circumferentially distributed and radially extending slots 60 wherein said slots 60 are open at one end. In use, the fingers 56 are adapted to be received within the slots 60 such that relative rotation of the first and second connectors is prevented. It should be noted that the free ends of the fingers 56 and the open ends of the slots 60 are tapered to assist in alignment of the fingers 56 with the slots 60 during make-up of the connecting assembly 14.

In an alternative arrangement (not illustrated), relative rotation between the first and second connectors 10, 12 may be prevented by a pin and slot arrangement. For example, an axial slot may be defined in surface region 62 (see FIG. 1A) of the tubular member 22 of the first connector 10, and a pin may be mounted in region 64 (see FIG. 1B) on the collet 26 of the second connector 12, wherein the pin is adapted to be received within the slot. In a preferred example, a plurality of circumferentially distributed slots are provided. Additionally, in the preferred example the pin is depressible against a biasing force such that if misalignment of the pin and any one of the slots occurs upon make-up of the connecting assembly 14 the pin will be depressed to prevent make-up being impeded. Upon initial relative rotation of the first and second connectors 10, 14 the pin will become aligned with and extend into one of the slots such that further relative rotation is prevented.

Referring still to FIGS. 1A, 1B, 2 and 3, the connecting assembly 14 further comprises an electrical connection arrangement adapted to permit electrical power and/or signals to be communicated across the connecting assembly 14. The electrical connection arrangement comprises a male electrical connection assembly 66 mounted in the electrical connection module 24 of the first connector 10, and a female electrical connection assembly 68 mounted in an end of the second connector 12. The male assembly 66 comprises a pin 70 coupled to a wire 72 via a nipple-type connection 74. The female assembly 60 comprises a socket portion 76 defining a bore 78 adapted to receive the pin 70. The socket portion 76 is secured to a wire 80 via a nipple-type connection 82.

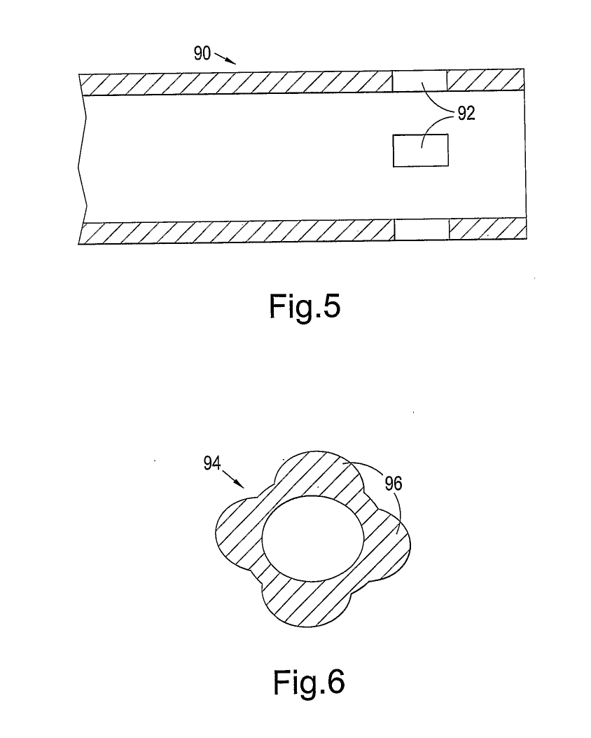

As described in detail above, the coupling members 18 are selectively supported and de-supported by axially translating the supporting member 20. In the embodiment disclosed above, an end of the supporting member 20 is translated into and out of engagement with the coupling members. However, in an alternative arrangement, shown in FIG. 5, the supporting member, in this case identified by reference numeral 90, comprises a plurality of recesses 92 which may be selectively aligned and misaligned with the coupling members 18. In this embodiment the supporting member 90 may be translated linearly or alternatively rotationally to move the slots 92 into and out of alignment with the coupling members 18.

In a further arrangement, shown in FIG. 6, a supporting member, identified by reference numeral 94 may comprise a plurality of lobes 96 corresponding to the number of coupling members 18. In use, the supporting member 94 may be rotated to support and de-support the coupling members 18 with the lobes 96.

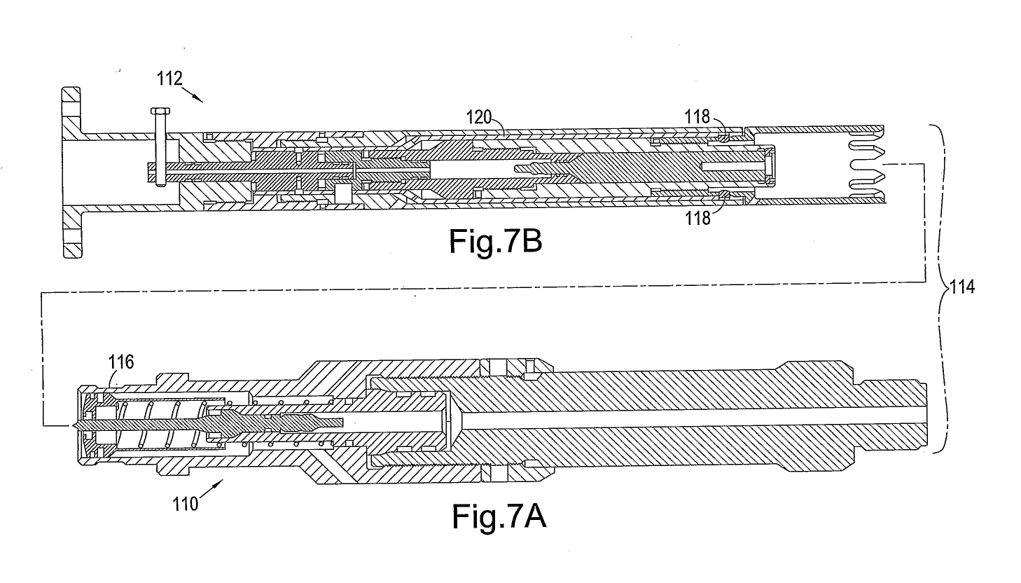

Reference is now made to FIGS. 7A and 7B in which there is shown a connecting assembly 114 in accordance with an alternative embodiment of the present invention. The connecting assembly 114 is similar to the assembly 14 described above and as such like components share like reference numerals. In view of the similarities between assembly 114 and assembly 14, only the difference will be described for clarity and brevity.

The connecting assembly 114 comprises a first electro-mechanical connector 110 shown in FIG. 7A and a second electro-mechanical connector 112 shown in FIG. 7B. In this embodiment the first connector 110 defines a male mechanical connector and the second connector 112 defines a female mechanical connector adapted to receive a portion of the first connector 110. The first connector 110 defines an annular recess 116 in an outer surface thereof. Additionally, the second connector 112 comprises a plurality of coupling members 118 which in this embodiment are in the form of keys. Upon engagement of the connectors 110, 112, the coupling members 118 are aligned with the annular recess 116 and a supporting member 120 in the form of a sleeve is axially translated to displace and secure the coupling members 18 within the recess 116. Accordingly, a secure connection may be achieved.

The mechanism for translating the supporting member 120 is similar to that described above and as such will not be described again.

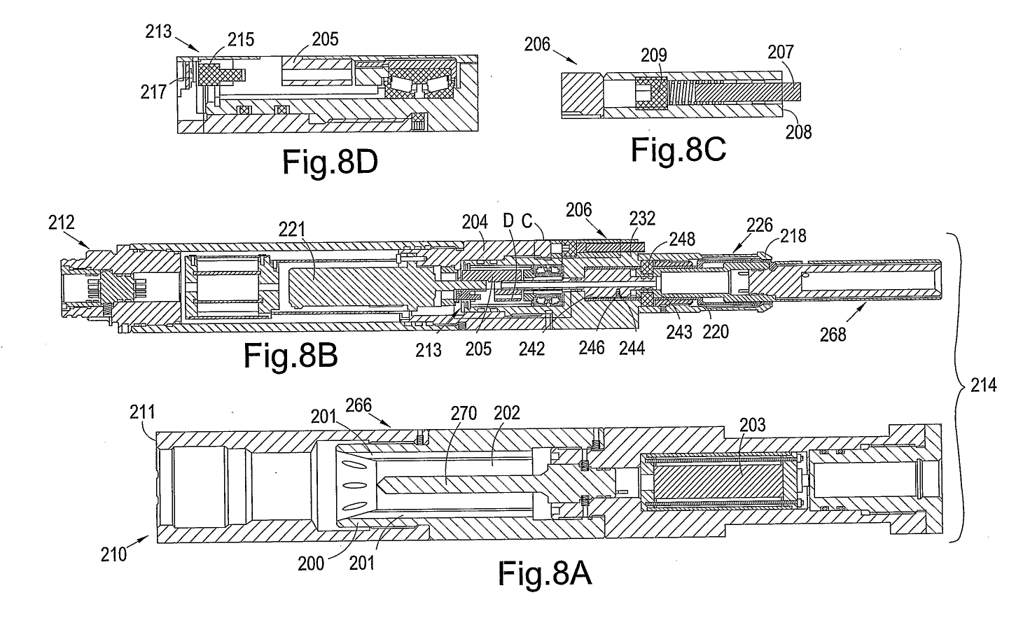

Reference is now made to FIGS. 8A and 8B in which there is shown a connecting assembly 214 in accordance with a further alternative embodiment of the present invention. The connecting assembly 214 is similar to the assembly 14 described above and as such like components share like reference numerals, incremented by 200. In view of the similarities between assembly 214 and assembly 14, only the difference will be described for clarity and brevity.

The first connecting assembly 210 includes an electrical assembly 266 which includes a pin 270. The pin 270 is surrounded by a sleeve 200 which includes a plurality of circumferentially distributed and axially extending throughbores 201. In use, the bores 201 permit fluids to be displaced from the annular space 202 upon insertion of the electrical assembly 268 of the second connector 212 and thus prevent or substantially eliminate hydraulic locking during make-up of the connecting assembly 214.

The first connector also includes an electronic module 203 which includes a programmable circuit, such as a PCB or microcontroller or the like. In use, the electronic module may be adapted to transmit a signal across the connecting assembly 214 once fully made up in order to confirm that an electrical connection has properly been established. Additionally, the electronic module 203 may include a unique signal identification such that the identification of the first connector 210 to which the second connector 212 has connected to may be established.

The second connector 212 also includes a collet sleeve 226 which is threadably mounted on a mounting member 232. The mounting member 232 is threadably secured to a motor support member 204 and a motor unit 221 is secured to the motor support member 204. The motor 221 is drivingly coupled to a displacement member 242 via an intermediate connecting sleeve 205, wherein the displacement member 242 is rotatably supported by the mounting member 232 and a bush member 243 which is formed in an upper portion of the electrical connection assembly 268.

The second connector 212 also includes a tubular supporting member 220 which is caused to be axially translated by a pin 244, slot 246 and key 248 arrangement similar to that described above with reference to the first embodiment. As such, no further description will be given.

The second connector 212 includes a first sensor arrangement 206 which is located in the region identified by reference letter C in FIG. 8B. For clarity, an enlarged view of region C is provided in FIG. 8C, reference to which is now additionally made. The first sensor arrangement 206 includes a spring mounted magnetic plunger 207 which extends axially into a circumferential face 208 of the mounting member. In a first position the plunger 207 protrudes from face 208. The first sensor arrangement 206 also includes a magnetic or hall effect sensor 209 which is adapted to identify the position of the plunger 207.

In use, upon make-up of the connecting assembly the plunger will engage a circumferential leading face 211 of the first connector 210 and will therefore be depressed into the mounting member 242, wherein such depression will be sensed by the magnetic sensor 209. Accordingly, the relative positioning of the first and second connectors 210, 212 may be established by the first sensor arrangement 206.

The second connector 212 also includes a second sensor arrangement 213 which is located in the region identified by reference letter D in FIG. 8B. For clarity, an enlarged view of region D is provided in FIG. 8D, reference to which is now additionally made. The second sensor arrangement 213 includes a magnetic reference body 215 secured to the intermediate connecting sleeve 205 which is arranged to be rotated by the motor 221. A fixed magnetic sensor 217 is mounted adjacent the connecting sleeve 205 and as such is adapted to determine the relative rotational position of the magnetic body, and hence connecting sleeve 205, and the magnetic sensor 217. As the displacement member 242 is rotatably coupled to the connecting sleeve 205 then the rotational position of the displacement member 242 may also be determined. Therefore, the axial position of the supporting sleeve 220 may be inferred by the established rotational position of the displacement member 242, and the precise location of the supporting member 242 between positions to support and de-support the coupling members 218 of the collet sleeve 226 may be determined.

Advantageously, the first and second sensor arrangements 206, 213 may be used to determine the state of connection of the connecting assembly 210 in that the first sensor arrangement 206 may determine whether or not the first and second connectors are engaged, and the second sensor arrangement 213 may determine whether or not the coupling members 218 are locked in place.

The present invention provides a connecting assembly that can be repeatedly made and broken with minimal risk of malfunction. Accordingly, the connecting assembly may be utilised in environments where access for maintenance and the like is severely restricted, such as in subsea systems.

It should be understood that the embodiments described herein are merely exemplary and that various modifications may be made thereto without departing from the scope of the invention. For example, the coupling members may take any appropriate form to permit engagement with the supporting member, and also may be provided in any appropriate number. Furthermore, the supporting member may directly or indirectly engage the coupling members. Also, the supporting member may be provided in the first connector. Additionally, the coupling members and the supporting member may be secured together, for example via a sliding connection such as a dovetail connection. Furthermore, the electrical connector may comprise more than one pin. In such an arrangement different electrical pin connections may be adapted to provide an independent type of electrical connection, such as for power or signals.

1. A connecting assembly comprising:
a first connector defining a profiled portion;
a second connector comprising a coupling member adapted to be translated to selectively engage with the profiled portion of the first connector;
a supporting member adapted to be translated to selectively secure said coupling member in engagement with the profiled portion of the first connector; and
drive means contained within one of the first and second connectors and adapted to translate the supporting member.

2. The connecting assembly according to claim 1, wherein the second connector comprises the supporting member.

3. The connecting assembly according to claim 1, wherein the drive means is contained within the connector comprising the supporting member.

4. The connecting assembly according to claim 1, further comprising a translation mechanism interposed between the drive means and the supporting member and adapted to transmit driving force from the drive means to the supporting member.

5. The connecting assembly according to claim 4, wherein the translation mechanism is adapted to rotate the supporting member.

6. The connecting assembly according to claim 4, wherein the translation mechanism is adapted to axially translate the supporting member.

7. The connecting assembly according to claim 4, wherein the translation mechanism comprises a displacement member coupled between the drive means and the supporting member, wherein movement of the displacement member by the drive means effects movement of the supporting member.

8. The connecting assembly according to claim 7, wherein the displacement member is adapted to be axially translated by the drive means.

9. The connecting assembly according to claim 7, wherein the displacement member is adapted to be rotatably translated by the drive means.

10. The connecting assembly according to claim 7, wherein the second connector further comprises a coupling arrangement disposed between the displacement member and the supporting member, wherein said coupling arrangement is adapted to permit movement of the displacement member to effect movement of the supporting member.

11. The connecting assembly according to claim 10, wherein the coupling arrangement is adapted to permit movement of the displacement member to cause corresponding movement of the supporting member.

12. The connecting assembly according to claim 10, wherein the coupling arrangement comprises an anti-rotation mechanism adapted to prevent the supporting member from being rotated.

13. The connecting assembly according to claim 12, wherein the anti-rotation mechanism comprises a key and key-way arrangement.

14. The connecting assembly according to claim 7, wherein at least one of the displacement member and supporting member defines a track and the other of the displacement member and supporting member comprises an extension element adapted to be engaged within said track.

15. The connecting assembly according to claim 14, wherein the track extends both axially and circumferentially to define a spiral arrangement such that rotation of the displacement member will effect linear movement of the supporting member.

16. The connecting assembly according to claim 1, wherein the coupling member is biased towards an extended position.

17. The connecting assembly according to claim 1, wherein the profiled portion is formed in a surface region of the first connector.

18. The connecting assembly according to claim 17, wherein the profiled portion comprises a recess formed in a portion of the first connector.

19. The connecting assembly according to claim 1, wherein the coupling member is mounted within a guide recess formed in a portion of the second connector.

20. The connecting assembly according to claim 1, wherein the coupling member is mounted on an axially extending member.

21. The connecting assembly according to claim 20, wherein the coupling member is mounted on a free end of the axially extending member, wherein an opposite end of said member is fixed relative to the second connector.

22. The connecting assembly according to claim 1, further comprising a sensor arrangement adapted to determine the state of connection of the first and second connectors.

23. The connecting assembly according to claim 22, wherein the sensor arrangement comprises a first sensor adapted to sense the position of the first connector relative to the second connector.

24. The connecting assembly according to claim 23, wherein the first sensor comprises a plunger mounted in one of the connectors and adapted to be engaged by the other of the connectors.

25. The connecting assembly according to claim 22, wherein the sensor arrangement comprises a second sensor adapted to sense the position of the supporting member relative to the coupling member.

26. The connecting assembly according to claim 1, further comprising an anti-rotation mechanism adapted to prevent or at least minimize relative rotation of the first and second connectors when secured together.

27. The connecting assembly according to claim 26, wherein the anti-rotation mechanism comprises an inter-engaging profiled arrangement defined between the first and second connectors.

28. The connecting assembly according to claim 26, wherein the anti-rotation mechanism comprises an axially extending channel formed in one of the first and second connectors, and a radially extending member in the other of the first and second connectors, wherein the radially extending member is adapted to be received with the channel to thus prevent relative rotation of the connectors.

29. The connecting assembly according to claim 28, wherein the radially extending member is adapted to be moved between extended and retracted positions.

30. The connecting assembly according to claim 1, wherein the connecting assembly further comprises an electrical connector assembly comprising first and second electrical connectors.

31. The connecting assembly according to claim 1, wherein at least one of the first and second connectors is adapted to be coupled to a spoolable medium.

32. The connecting assembly according to claim 1, adapted for use in a wellbore tool deployment apparatus.

33. A method of forming a connection between first and second connectors comprising the steps of:
bringing first and second connectors together;
translating a coupling member provided on the second connector into a profiled portion formed in the first connector; and
translating a supporting member via drive means mounted in at least one of the first and second connectors to secure said coupling member in engagement with the profiled portion of the first connector.

34. A tool deployment system comprising:
a tool;
a spoolable medium; and
a connecting assembly adapted to couple said tool to said spoolable medium, wherein the connecting assembly comprises a first connector defining a profiled portion, a second connector comprising a coupling member adapted to be translated to selectively engage with the profiled portion of the first connector, a supporting member adapted to be translated to selectively secure said coupling member in engagement with the profiled portion of the first connector, and drive means for translating the supporting member.

35. A method of performing a well intervention, said method comprising the steps of:
selecting a well intervention tool from a tool storage package;
securing said tool to a spoolable medium using a connecting assembly; and
running said tool into a wellbore on the spoolable medium, wherein the connecting assembly comprises:
a first connector defining a profiled portion;
a second connector comprising a coupling member adapted to be translated to selectively engage with the profiled portion of the first connector;
a supporting member adapted to be translated to selectively secure said coupling member in engagement with the profiled portion of the first connector; and
drive means contained within one of the first and second connectors and adapted to translate the supporting member.
